(19) United States
(12) Patent Application Publication
(10) Pub. No.: US 2017/0247940 A1
(43) Pub. Date: Aug. 31, 2017

(54) PROTECTIVE GRID WITH ADJUSTABLE SIZE

(71) Applicant: Jun TANG, Anhui (CN)

(72) Inventor: Jun TANG, Anhui (CN)

(21) Appl. No.: 15/593,340

(22) Filed: May 12, 2017

Related U.S. Application Data
(63) Continuation of application No. PCT/CN2015/076393, filed on Apr. 13, 2015.

(30) Foreign Application Priority Data
Nov. 12, 2014 (CN) 201410635972.8

(51) Int. Cl. E06B 9/01

(52) U.S. Cl. CPC E06B 9/01

(57) ABSTRACT

The present invention relates to the field of protective grids, and more particularly, to a protective grid with an adjustable size, comprising frames which are composed of horizontal frames and vertical frames, an adjusting device which is used for connecting the horizontal frames and the vertical frames and comprises connecting blocks, and screws via which the connecting blocks are connected between the horizontal frames and the vertical frames. It is convenient to adjust and can fit the size of different window frames; the modular setting makes the production convenient and is favorable for a large-scale production.

### CROSS-REFERENCE TO RELATED APPLICATION

This is a continuation of International Application No. PCT/CN2015/076393, filed on Apr. 13, 2015, which claims the priority benefits of China Application No. 201410635972.8, filed on Nov. 12, 2014. The entirety of each of the above-mentioned patent applications is hereby incorporated by reference herein and made a part of this specification.

### BACKGROUND OF THE INVENTION

Technical Field

The present invention relates to the field of protective grids, and more particularly, to a protective grid with an adjustable size.

2. Description of Related Art

Existing protective grids are usually composed of frames and grids, and there are two ways of connection: first, the stainless steel materials or iron art products are connected via welding; secondly, the aluminum alloy materials are connected via mortising. The assemblies of frames and grids are transported to an installation site after being fixed in the factory. The deficiencies are as follows: the size of the width and height must be determined by a professional who pays a visit to measure the size of a window, which generates more costs; it is hard to put into standardized production due to a plurality of sizes.

### BRIEF SUMMARY OF THE INVENTION

This invention provides a protective grid with an adjustable size, which solves the problem of the length and width of a protective grid being unadjustable and the grid being difficult to install by way of adding connecting blocks.

The present invention provides a protective grid with an adjustable size, comprising frames which are composed of horizontal frames and vertical frames, an adjusting device which is used for connecting the horizontal frames and the vertical frames and comprises connecting blocks, and screws via which the connecting blocks are connected between the horizontal frames and the vertical frames. The length of the frames is adjusted in such a manner that the connecting blocks are sequentially connected for the purpose of adjusting the protective grid.

A further technical solution of the present invention is that the connecting block comprises a first mating protrusion and a first mating recess used for engaging the first mating protrusion, so as to facilitate the connection and alignment between the connecting blocks.

A further technical solution of the present invention is that the connecting block is provided with a first threaded protrusion and a first threaded recess capable of engaging the first threaded protrusion, so as to facilitate the connection and alignment between the connecting blocks.

A further technical solution of the present invention is that the connecting block is further provided with through holes, so as to facilitate the passing of the screws and fasten the fixation.

A further technical solution of the present invention is that the adjusting device further comprises rectangular blocks, wherein two end faces of the rectangular blocks which are vertical to each other are connected with the connecting blocks, with the end faces of the rectangular blocks provided with through holes, so as to facilitate the connection between the two frames which are vertical to each other.

A further technical solution of the present invention is that the adjusting device further comprises T-portion connecting blocks, and the T-portion connecting blocks further comprise a second mating protrusion and a third mating protrusion used for engaging the first connecting recess; the vertical frame further comprises an axis and is further provided on the side parallel to the axis with a second mating recess used for engaging the second mating protrusion, so as to facilitate the connection of the internal frames of the protective grid, as well as the alignment, and to fasten the connection.

To solve the above technical problems, a technical solution further provided in the invention is a protective grid with an adjustable size, comprising frames which are composed of horizontal frames and vertical frames, an adjusting device which is used for connecting the horizontal frames and the vertical frames and comprises a first mating block and a sleeving block used for sleeving the mating block on the outer side, and screws via which the first mating block and the sleeving block are connected between the horizontal frames and the vertical frames. The purpose of adjusting the overall length of the frame by way of increasing or decreasing the sleeving block is achieved in the manner of internal orientation and external adjustment.

A further technical solution of the present invention is that the first mating block comprises drawers and rectangular blocks used for connecting two of the drawers vertical to each other, and the end faces of the rectangular blocks which are connected with the drawers are provided with through holes, so as to facilitate the connection of the internal frames of the protective grid as well as the alignment, and secure the connection.

To solve the above technical problems, a technical solution further provided in the invention is a protective grid with an adjustable size, comprising frames which are composed of horizontal frames and vertical frames, an adjusting device which is used for connecting the horizontal frames and the vertical frames and comprises a third mating block, and screws via which the third mating block is connected between the horizontal frames and the vertical frames. The adjusting device is integrally designed to facilitate manufacturing, and the length of the frame can be adjusted by way of cutting the length of the third block.

A further technical solution of the present invention is that the third mating block is provided with an adjusting portion and a connecting portion used for connecting the adjusting portion, wherein the adjusting portion of a hollow structure is provided with sequentially connected recesses and protrusions, and the end faces of the connecting portion which are connected with the adjusting portion are provided with through holes. The recess facilitates the cutting of the third mating block while the end portion within the recess can also be inserted into the frame for fixation, and the outer edge of the protrusion is consistent with the frame in size so as to facilitate the positioning and fixation.

The beneficial effects of the present invention are as below: it is convenient to adjust and can fit the size of different window frames. The modular setting makes the production convenient and is favorable for large-scale production.

### BRIEF DESCRIPTION OF THE SEVERAL VIEWS OF THE DRAWINGS

FIG. 1 is an overall view of all embodiments of the present invention;

FIG. 2 is a perspective view of the connecting block provided according to Embodiment 1 of the present invention;

FIG. 3 is another perspective view of a connecting block provided according to Embodiment 1 of the present invention;

FIG. 4 is a perspective view of the T-portion connecting block provided according to Embodiment 1 of the present invention;

FIG. 5 is a perspective view of the connecting block according to Embodiment 2 of the present invention;

FIG. 6 is a perspective view of the rectangular block provided according to Embodiment 2 of the present invention;

FIG. 7 is another perspective view of the rectangular block provided according to the Embodiment 2 of the present invention;

FIG. 8 is a perspective view of the first mating block provided according to Embodiment 3 of the present invention;

FIG. 9 is a perspective view of the sleeving block provided according to Embodiment 3 of the present invention; and

FIG. 10 is a perspective view of the third mating block provided in Embodiment 4 of the present invention.

### DETAILED DESCRIPTION OF THE INVENTION

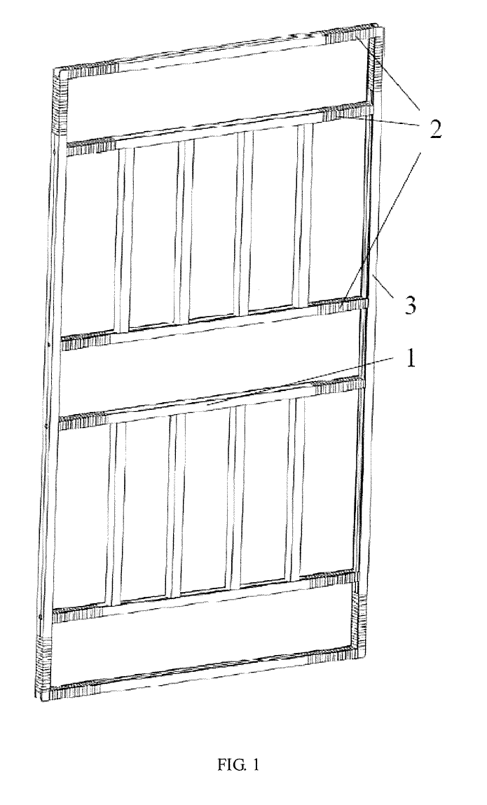

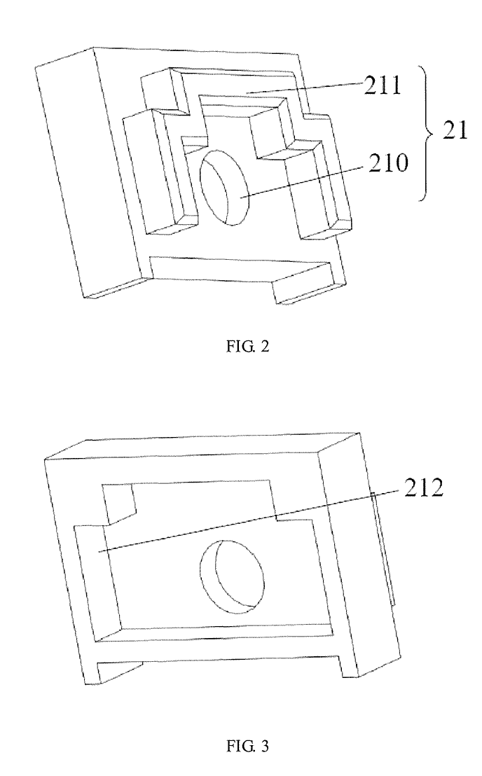

Embodiment 1 as shown in FIG. 1 to FIG. 3: a protective grid with an adjustable size, comprising frames which are composed of horizontal frames 1 and vertical frames 3, an adjusting device 2 which is used for connecting the horizontal frames 1 and the vertical frames 3 and comprises connecting blocks, and screws via which the connecting blocks are connected between the horizontal frames 1 and the vertical frames 3. The connecting blocks are sequentially connected to form the adjusting device 2, and the length of the adjusting device 2 is adjusted by way of adjusting the number of the connecting blocks. The length of the frame is changed by way of adding the adjusting device 2 and changing the number of the connecting blocks. It can facilitate the adjustment of the width of the protective grid so as to meet the needs of most customers.

The connecting block in the embodiment is the connecting block 21, which comprises a first mating protrusion 211 and a first mating recess 212 used for engaging the first mating protrusion 211. In the process of interconnection between the connecting blocks 21, the first mating protrusion 211 of the previous connecting block 21 can be inserted into the first mating recess 212 of the latter connecting block so as to facilitate the alignment to avoid deviation in the process of fixation via screws. It can ensure the interconnection between the blocks and secure the connection, which facilitates the installation.

The connecting block 21 is further provided with through holes 210. The axis of the through hole 210 is parallel to the connecting direction of the connecting block, or parallel to the direction of the long axis of the frame. The screw can be fixed through a through hole into a screw groove on the frame.

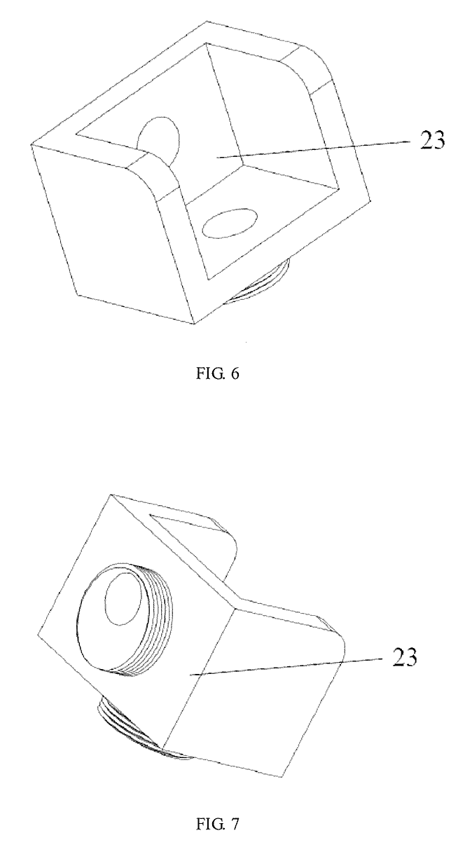

The adjusting device 2 further comprises a rectangular block which is similar to the rectangular blocks in FIG. 6 and FIG. 7, and two end faces of the rectangular blocks perpendicular to each other are connected with the connecting blocks, that is, the two faces of the rectangular block are provided with the first mating protrusion 211 instead of the threaded protrusion as shown in FIG. 7. The end faces of the rectangular block are provided with through holes. It facilitates the connection between the rectangular block and the connecting block.

The adjusting device 2 further comprises T-portion connecting blocks 24, and the T-portion connecting blocks 24 further comprise a second mating protrusion 241 and a third mating protrusion 242 used for engaging the first connecting recess; the vertical frame 3 further comprises an axis and is further provided on the side parallel to the axis with a second mating recess used for engaging the second mating protrusion 241, that is, a protruding end is provided on one side of the vertical frame 3 and it engages the vertical frame 3 to fix the T-portion connecting block 24.

Embodiment 2 as shown in FIG. 1, FIG. 5, FIG. 6 and FIG. 7: a protective grid with an adjustable size, comprising frames which are composed of horizontal frames 1 and vertical frames 3, an adjusting device 2 which is used for connecting the horizontal frames I and the vertical frames 3 and comprises connecting blocks, and screws via which the connecting blocks are connected between the horizontal frames 1 and the vertical frames 3. The connecting blocks are sequentially connected to form the adjusting device 2, and the length of the adjusting device 2 is adjusted by way of adjusting the number of the connecting blocks. The length of the frame is changed by way of adding the adjusting device 2 and changing the number of the connecting blocks. It can facilitate the adjustment of the width of the protective grid so as to meet the needs of most customers.

The connecting block 22 in Embodiment 2 is provided with a first threaded protrusion and a first threaded recess 221 capable of engaging the first threaded protrusion, as shown in FIG. 5, that is, the connection between the blocks is realized via the thread, so that the connection is tighter and not easy to loosen.

The connecting block is further provided with through holes 210. The axis of the through hole is parallel to the connecting direction of the connecting block, or parallel to the frame. The screw can be fixed through a through hole into a screw groove on the frame.

The adjusting device 2 further comprises rectangular blocks, as shown in FIG. 6 and FIG. 7, wherein two end faces of the rectangular blocks which are vertical to each other are connected with the connecting blocks, with the end faces of the rectangular blocks provided with through holes. And meanwhile the end faces of the rectangular block used for connecting the connecting block in Embodiment 1 are further provided with a first threaded protrusion which facilitates the connection between the rectangular block and the connecting block.

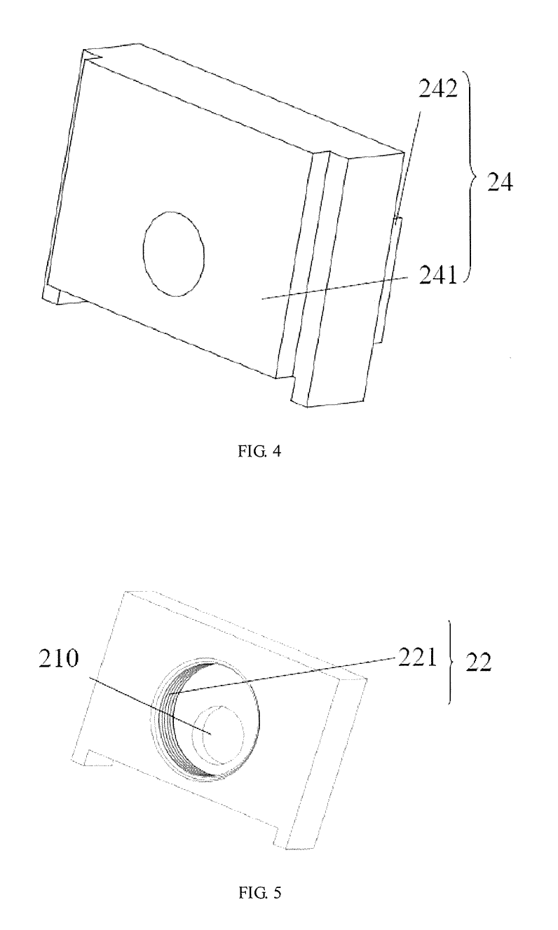

The adjusting device 2 further comprises T-portion connecting blocks, and the T-portion connecting blocks further comprise a second mating protrusion 241 and a second threaded protrusion used for engaging the first threaded recess 221; the vertical frame 3 further comprises an axis and is further provided on the side parallel to the axis with a second mating recess used for engaging the second mating protrusion 241. The T-portion connecting block in this embodiment is similar to that shown in FIG. 4, but the threaded protrusion is used instead of the mating protrusion in the figure so as to facilitate the connection of the connecting block 22 with the threaded groove in this embodiment.

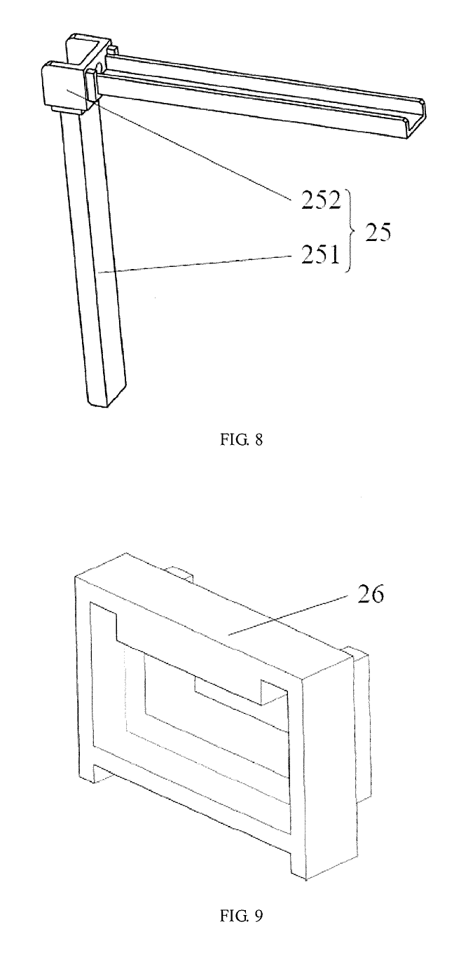

Embodiment 3 as shown in FIG. 1, FIG. 8 and FIG. 9: a protective grid with an adjustable size, comprising frames which are composed of horizontal frames 1 and vertical frames 3, an adjusting device 2 which is used for connecting the horizontal frames 1 and the vertical frames 3 and comprises a first mating block 25 and a sleeving block 26 used for sleeving the mating block on the outer side, and screws via which the first mating block 25 and the sleeving block 26 are connected between the horizontal frames 1 and the vertical frames 3.

The first mating block 25 comprises drawers 251 and rectangular blocks 252 used for connecting two of the drawers 251 vertical to each other, wherein the drawer 251 has a U-shaped cross section, and the end faces of the rectangular blocks 252 which are connected with the drawers 251 are provided with through holes.

The sleeving block 26 is of a hollow structure, with both end faces provided with mating protrusions and mating recesses which facilitate the engagement with the mating protrusions.

The process of the implementation: the sleeving block 26 is sleeved on the drawer 251, and the drawer 251 is inserted into the frame and fixed on the frame via the screws which are inserted into the through holes of the rectangular block 252. The length and width of the protective grid are adjusted by way of adjusting the number of the sleeving blocks 26.

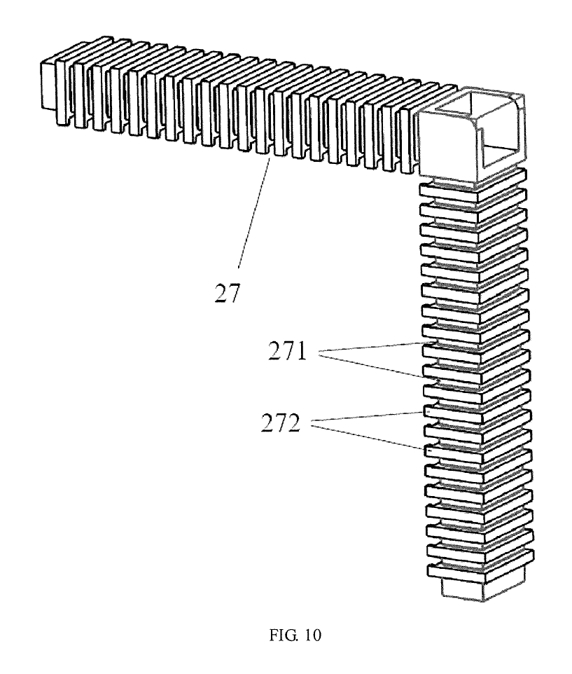

Embodiment 4 as shown in FIG. 1 and FIG. 10: a protective grid with an adjustable size, comprising frames which are composed of horizontal frames 1 and vertical frames 3, an adjusting device 2 which is used for connecting the horizontal frames 1 and the vertical frames 3 and comprises third blocks 27, and screws via which the third mating blocks 27 are connected between the horizontal frames 1 and the vertical frames 3.

The third mating block 27 is provided with an adjusting portion and a connecting portion used for connecting the adjusting portion, wherein the adjusting portion of a hollow structure is provided with sequentially connected recesses 271 and protrusions 272, and the end faces of the connecting portion which are connected with the adjusting portion are provided with through holes.

The adjusting portion refers to the recess 271 and the protrusion 272 sequentially connected on the third mating block 27. The connecting portion refers to the rectangular block which is used for connecting the two adjusting portions vertical to each other in the figure, wherein the rectangular block is provided with the through holes which facilitates the passing of the screws which can pass through the adjusting portion of a hollow structure to be fixed onto the frames.

The foregoing are only preferred embodiments of the present invention and are not intended to limit the present invention. Any modifications, equivalent substitutions and improvements based on the spirit and principle of the present invention shall be covered in the protection scope of the present invention.

What is claimed is:

1. A protective grid with an adjustable size, comprising: frames which are composed of horizontal frames and vertical frames, an adjusting device which is used for connecting the horizontal frames and the vertical frames and comprises connecting blocks, and screws via which the connecting blocks are connected between the horizontal frames and the vertical frames.

2. The protective grid with an adjustable size as claimed in claim 1, wherein the connecting block comprises a first mating protrusion and a first mating recess used for engaging the first mating protrusion.

3. The protective grid with an adjustable size as claimed in claim 1, wherein the connecting block is provided with a first threaded protrusion and a first threaded recess capable of engaging the first threaded protrusion.

4. The protective grid with an adjustable size as claimed in claim 1, wherein the connecting block is further provided with through holes.

5. The protective grid with an adjustable size as claimed in claim 4, wherein the adjusting device further comprises rectangular blocks, wherein two end faces of the rectangular blocks which are vertical to each other are connected with the connecting blocks, with the end faces of the rectangular blocks provided with through holes.

6. The protective grid with an adjustable size as claimed in claim 4, wherein the adjusting device further comprises T-portion connecting blocks, and the T-portion connecting blocks further comprise a second mating protrusion and a third mating protrusion used for engaging the first connecting recess; the vertical frame further comprises an axis and is further provided on the side parallel to the axis with a second mating recess used for engaging the second mating protrusion.

7. The protective grid with an adjustable size as claimed in claim 2, wherein the connecting block is further provided with through holes.

8. The protective grid with an adjustable size as claimed in claim 7, wherein the adjusting device further comprises rectangular blocks, wherein two end faces of the rectangular blocks which are vertical to each other are connected with the connecting blocks, with the end faces of the rectangular blocks provided with through holes.

9. The protective grid with an adjustable size as claimed in claim 7, wherein the adjusting device further comprises T-portion connecting blocks, and the T-portion connecting blocks further comprise a second mating protrusion and a third mating protrusion used for engaging the first connecting recess; the vertical frame further comprises an axis and is further provided on the side parallel to the axis with a second mating recess used for engaging the second mating protrusion.

10. The protective grid with an adjustable size as claimed in claim 3, wherein the connecting block is further provided with through holes.

11. The protective grid with an adjustable size as claimed in claim 10, wherein the adjusting device further comprises rectangular blocks, wherein two end faces of the rectangular blocks which are vertical to each other are connected with the connecting blocks, with the end faces of the rectangular blocks provided with through holes.

12. The protective grid with an adjustable size as claimed in claim 10, wherein the adjusting device further comprises T-portion connecting blocks, and the T-portion connecting blocks further comprise a second mating protrusion and a third mating protrusion used for engaging the first connecting recess; the vertical frame further comprises an axis and is further provided on the side parallel to the axis with a second mating recess used for engaging the second mating protrusion.

13. A protective grid with an adjustable size, comprising: frames which are composed of horizontal frames and vertical frames, an adjusting device which is used for connecting the horizontal frames and the vertical frames and comprises a first mating block and a sleeving block used for sleeving the mating block on the outer side, and screws via which the first mating block and the sleeving block are connected between the horizontal frames and the vertical frames.

14. The protective grid with an adjustable size as claimed in claim 13, wherein the first mating block comprises drawers and rectangular blocks used for connecting two of the drawers vertical to each other.

15. The protective grid with an adjustable size as claimed in claim 14, wherein the end faces of the rectangular blocks which are connected with the drawers are provided with through holes.

16. A protective grid with an adjustable size, comprising: frames which are composed of horizontal frames and vertical frames, an adjusting device which is used for connecting the horizontal frames and the vertical frames and comprises a third mating block, and screws via which the third mating block is connected between the horizontal frames and the vertical frames.

17. The protective grid with an adjustable size as claimed in claim 16, wherein the third mating block is provided with an adjusting portion and a connecting portion used for connecting the adjusting portion, wherein the adjusting portion of a hollow structure is provided with sequentially connected recesses and protrusions, and the end faces of the connecting portion which are connected with the adjusting portion are provided with through holes.
